(19) United States
(12) Patent Application Publication
(10) Pub. No.: US 2023/0153606 A1
(43) Pub. Date: May 18, 2023

(54) COMPOSITIONAL TEXT-TO-IMAGE SYNTHESIS WITH PRETRAINED MODELS

(71) Applicant: NEC Laboratories America, Inc., Princeton, NJ (US)

(72) Inventors: Renqiang Min, Princeton, NJ (US); Kai Li, Princeton, NJ (US); Hans Peter Graf, South Amboy, NJ (US); Zhiheng Li, Rochester, NY (US)

(21) Appl. No.: 17/968,923

(22) Filed: Oct. 19, 2022

Related U.S. Application Data
(60) Provisional application No. 63/279,065, filed on Nov. 12, 2021.

(51) Int. Cl. G06N 3/08; G06N 3/04; G06F 40/30; G06V 10/774; G06V 10/82; G06F 40/279

(52) U.S. Cl. CPC G06N 3/08; G06N 3/0454; G06F 40/30; G06V 10/774; G06V 10/82; G06F 40/279

(57) ABSTRACT

A method is provided that includes training a CLIP model to learn embeddings of images and text from matched image-text pairs. The text represents image attributes. The method trains a StyleGAN on images in a training dataset of matched image-text pairs. The method also trains, using a CLIP model guided contrastive loss which attracts matched text embedding pairs and repels unmatched pairs, a text-to-direction model to predict a text direction that is semantically aligned with an input text responsive to the input text and a random latent code. A triplet loss is used to learn text directions using the embeddings learned by the trained CLIP model. The method generates, by the trained StyleGAN, positive and negative synthesized images by respectively adding and subtracting the text direction in the latent space of the trained StyleGAN corresponding to a word for each of the words in the training dataset.

### RELATED APPLICATION INFORMATION

This application claims priority to U.S. Provisional Patent Application No. 63/279,065, filed on Nov. 12, 2021, incorporated herein by reference in its entirety.

### BACKGROUND

### Technical Field

The present invention relates to text to image processing and more particularly to compositional text-to-image synthesis with pretrained models.

### Description of the Related Art

Generative models have gained phenomenal interest in the research community as they provide a promise for unsupervised representation learning. Generative Adversarial Networks have been one of the most successful generative models till date. Following its advent in 2014, tremendous progress has been made towards improving the stability, quality and the diversity of the generated images. Generating images directly from text is much harder than unconditional image generation because each textual input can correspond to many different images that convey the same semantic meaning.

### SUMMARY

According to aspects of the present invention, a computer-implemented method is provided. The method includes training, by a hardware processor, a Contrastive Language-Image Pre-Training (CLIP) model to learn embeddings of images and text from matched image-text pairs to obtain a trained CLIP model. The text represents image attributes for the images to which the text are matched. The method further includes training, by the hardware processor, a Style Generative Adversarial Network (StyleGAN) on images in a training dataset of matched image-text pairs to obtain a trained StyleGAN. The method also includes training, by the hardware processor using a CLIP model guided contrastive loss which attracts matched text embedding pairs and repels unmatched text embedding pairs in a latent space of the trained StyleGAN, a text-to-direction model to predict a text direction that is semantically aligned with an input text responsive to the input text and a random latent code in a latent space of the pretrained StyleGAN. A triplet loss is used to learn text directions using the embeddings learned by the trained CLIP model. The method additionally includes generating, by the trained StyleGAN, positive and negative synthesized images by respectively adding and subtracting the text direction in the latent space of the trained StyleGAN corresponding to a word for each of the words in the training dataset.

According to other aspects of the present invention, a computer program product for text-to-image synthesis is provided. The computer program product includes a non-transitory computer readable storage medium having program instructions embodied therewith. The program instructions are executable by a computer to cause the computer to perform a method. The method includes training, by a hardware processor, a Contrastive Language-Image Pre-Training (CLIP) model to learn embeddings of images and text from matched image-text pairs to obtain a trained CLIP model. The text represents image attributes for the images to which the text are matched. The method further includes training, by the hardware processor, a Style Generative Adversarial Network (StyleGAN) on images in a training dataset of matched image-text pairs to obtain a trained StyleGAN. The method also includes training, by the hardware processor using a CLIP model guided contrastive loss which attracts matched text embedding pairs and repels unmatched text embedding pairs in a latent space of the trained StyleGAN, a text-to-direction model to predict a text direction that is semantically aligned with an input text responsive to the input text and a random latent code in a latent space of the pretrained StyleGAN. A triplet loss is used to learn text directions using the embeddings learned by the trained CLIP model. The method additionally includes generating, by the trained StyleGAN, positive and negative synthesized images by respectively adding and subtracting the text direction in the latent space of the trained StyleGAN corresponding to a word for each of the words in the training dataset.

According to still other aspects of the present invention, a computer processing system is provided. The computer processing system includes a memory device for storing program code. The computer processing system further includes a hardware processor operatively coupled to the memory device for running the program code to train a Contrastive Language-Image Pre-Training (CLIP) model to learn embeddings of images and text from matched image-text pairs to obtain a trained CLIP model. The text represents image attributes for the images to which the text are matched. The hardware processor further runs the program code to train a Style Generative Adversarial Network (StyleGAN) on images in a training dataset of matched image-text pairs to obtain a trained StyleGAN. The hardware processor also runs the program code to train, using a CLIP model guided contrastive loss which attracts matched text embedding pairs and repels unmatched text embedding pairs in a latent space of the trained StyleGAN, a text-to-direction model to predict a text direction that is semantically aligned with an input text responsive to the input text and a random latent code in a latent space of the pretrained StyleGAN. A triplet loss is used to learn text directions using the embeddings learned by the trained CLIP model. The trained StyleGAN generates positive and negative synthesized images by respectively adding and subtracting the text direction in the latent space of the trained StyleGAN corresponding to a word for each of the words in the training dataset.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 gives an overview of a StyleT2I framework, in accordance with an embodiment of the present invention;

FIG. 3 is a block diagram identifying disentangled attribute directions by training an Attribute-to-Direction module with proposed semantic matching loss (L_{semantic}) and Spatial Constraint (Lₛₚₐₜᵢₐₗ), in accordance with an embodiment of the present invention;

FIG. 4 is a block diagram showing an exemplary environment to which the present invention can be applied, in accordance with an embodiment of the present invention; and

FIG. 5-6 are block diagrams showing an exemplary method, in accordance with an embodiment of the present invention.

### DETAILED DESCRIPTION OF PREFERRED EMBODIMENTS

Embodiments of the present invention are directed to compositional text-to-image synthesis with pretrained models.

In an embodiment, the problem of text conditioned image synthesis is tackled where the input argument is a text description and the goal is to synthesize an image corresponding to the input text. Specifically, embodiments of the present invention focus on synthesizing novel/underrepresented compositions of attributes. This problem has several applications, some of which include multimedia applications, generating synthetic dataset for training AI-based danger prediction systems, training AI surveillance systems, and self-driving control systems, model-based reinforcement learning systems, domain adaptation, etc. Our approach generating data with novel compositional attributes can lead to robust classification under distributional shift and alleviate bias and fairness issues.

The present invention obtains a pretrained CLIP model on a large-scale public dataset with matched pairs of image and text, which generates embeddings of words (attributes) and images.

Given a training dataset of matched image-text pairs, the present invention pre-trains a StyleGAN on the set of images. The present invention then uses a direction in the pretrained GAN's latent space to edit an image with respect to an attribute. Based on the pre-trained StyleGAN, the present invention generates positive or negative examples by adding or subtracting a direction corresponding to an attribute. The present invention uses triplet loss to learn these attribute-specific directions using embeddings learned from the pretrained CLIP model.

The present invention concatenates the embedding of an input sentence and a latent vector to predict a composite direction in the latent space of the pretrained StyleGAN to generate images from the given text. During the training, the present invention maximizes the cosine similarity between each input text-induced attribute direction and the composite direction if they disagree; during the editing, the present invention adds each input text-induced attribute direction to the composite direction if they disagree.

The present invention also maps attributes to W+ space of StyleGAN and use segmentation maps to guide the disentanglement of the attribute directions.

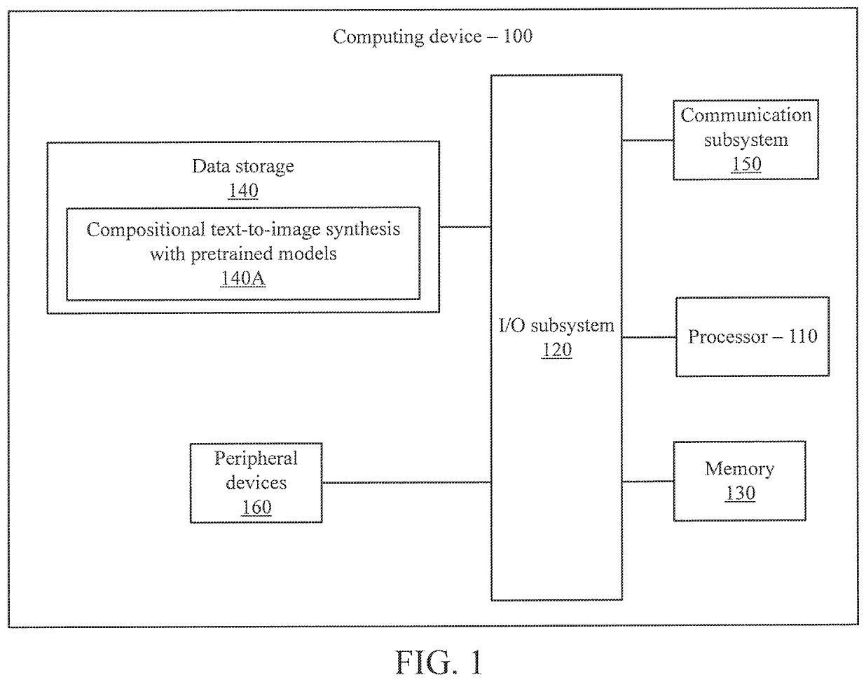

FIG. 1 is a block diagram showing an exemplary computing device 100, in accordance with an embodiment of the present invention. The computing device 100 is configured to perform compositional text-to-image synthesis with pretrained models.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for compositional text-to-image synthesis with pretrained models. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

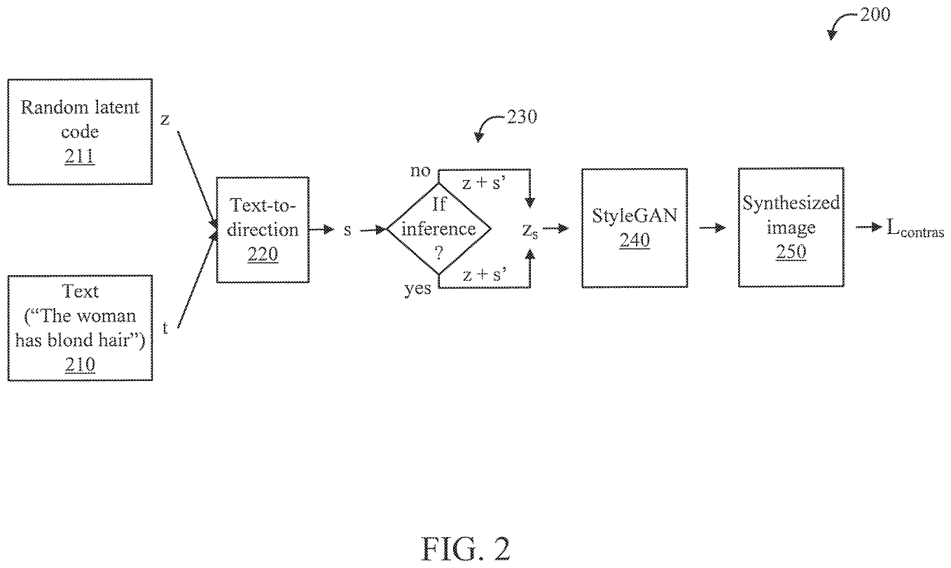

FIG. 2 gives an overview of a StyleT2I framework 200, in accordance with an embodiment of the present invention. Unlike most previous end-to-end approaches, we leverage a pretrained unconditional generator, Style-GAN 240, and focus on finding a text-conditioned latent code in generator's latent space that can be decoded into a high fidelity image aligned with the input text.

To achieve this, we present a Text-to-Direction module/model 220 trained with novel CLIP-guided Contrastive Loss for better distinguishing different compositions against different texts, and applied with a norm penalty to preserve the high fidelity of the synthesized image 250.

To further improve the compositionality of the text-to-image synthesis results, we propose novel Semantic Matching Loss and Spatial Constraint for identifying semantically matched and disentangled attribute latent directions, which will be used to adjust the text-conditioned latent code during the inference stage with our novel Compositional Attributes Adjustment (CAA).

Text-Conditioned Latent Code Prediction

As many previous works show that the latent direction in StyleGAN's latent space can represent an attribute—traversing a latent code along the attribute's latent direction can edit the attribute in the synthesized image, we hypothesize that there exists a latent direction that corresponds to the semantic meaning of multiple attributes described in the input text, e.g., “gender” and “blond hair” attributes in text “The woman has blond hair.” Therefore, to find a latent code in a pretrained StyleGAN's latent space that is consistent with the input text, we propose a Text-to-Direction module 220 that takes a randomly sampled latent code z and the text t as the input. The output is a latent direction s, dubbed sentence direction, to edit the latent code z, resulting in the text-conditioned code zₛ=z+s. As a result, the sentence code zₛ 230 is fed into the StyleGAN generator G to synthesize the fake image Î=G(zₛ).

CLIP-Guided Contrastive Loss

The Text-to-Direction module should not only predict the sentence direction that is semantically aligned with the input text, but also avoid simply memorizing the compositions in the training data. To achieve this, we leverage CLIP, which is pretrained on a large dataset of (image, caption) pairs to learn a joint embedding space of text and image, as the conditional discriminator. Based on CLIP and contrastive loss, we propose a novel CLIP-guided Contrastive Loss to train the Text-to-Direction module. Formally, given a batch of B text {tᵢ}ᵢ₋₀^{B} sampled from the training data and the corresponding fake images Îᵢ we compute the CLIP-guided Contrastive Loss of the i-th fake image as:

$${L}_{contras} ( {I}_{i} ) = - log \frac{exp ( cos ( {E}_{C L I P}^{i m g} ( {\hat{I}}_{i} ) , {E}_{C L I P}^{t e x t} ( {t}_{i} ) ) )}{{Σ}_{j \neq i}^{B} exp ( cos ( {E}_{C L I P}^{i m g} ( {\hat{I}}_{i} ) , {E}_{C L I P}^{t e x t} ( {t}_{j} ) ) )} , \qquad ( 1 )$$

where E_{CLIP}^{img} and E_{CLIP}^{text} denotes the image encoder and text encoder of CLIP, respectively. cos(⋅,⋅) denotes the cosine similarity. CLIP-guided Contrastive Loss attracts and paired text embedding and fake image embedding in CLIP's joint feature space and repels the embedding of unmatched pairs. In this way, Text-to-Direction module 220 is trained to better align the sentence direction s with the input text t. At the same time, CLIP-guided Contrastive Loss forces the Text-to-Direction module 220 to contrast the different compositions in different texts, e.g., “he is wearing lipstick” and “she is wearing lipstick,” which prevents the network from overfitting to compositions that predominate in the training data.

Norm Penalty for High-Fidelity Synthesis

However, experimental results show that minimizing the contrastive loss alone fails to guarantee the fidelity of the synthesized image. We observe that CLIP-guided Contrastive Loss (Eq. (1)) alone makes the Text-to-Direction module 220 predict s with a large l² norm, resulting in zₛ shifted to the low-density region in the latent distribution, leading to lower image quality. Therefore, we penalize the l² norm of sentence direction s when it exceeds a threshold hyperparameter θ:

Lnorm=max(∥s∥₂−θ,0). (2)

An ablation study shows that adding the norm penalty strikes a better balance between the text-image alignment and quality.

To summarize, the full objective function for training the Text-to-Direction module 220 is:

Lₛ=L_{contras}+Lₙₒᵣₘ. (3)

Compositionality with Attribute Directions

To further improve the compositionality, we first identify the latent directions representing the attributes with novel Semantic Matching Loss and Attribute Region Constraint. Then, we propose Compositional Attributes Adjustment to adjust the sentence direction by the identified attribute directions to perform to improve the compositionality of text-to-image synthesis results.

Identify Attribute Directions via Semantic Matching Loss

To identify all latent directions of all attributes existing in the dataset, we first build a vocabulary of attributes, e.g., “smiling,” “blond hair,” attributes in a face image dataset, where each attribute is represented by a word or a short phrase. Then, we extract the attributes in each sentence in the dataset based on string matching or dependency parsing. For example, “woman” and “blond hair” attributes are extracted from the sentence “the woman has blond hair.”

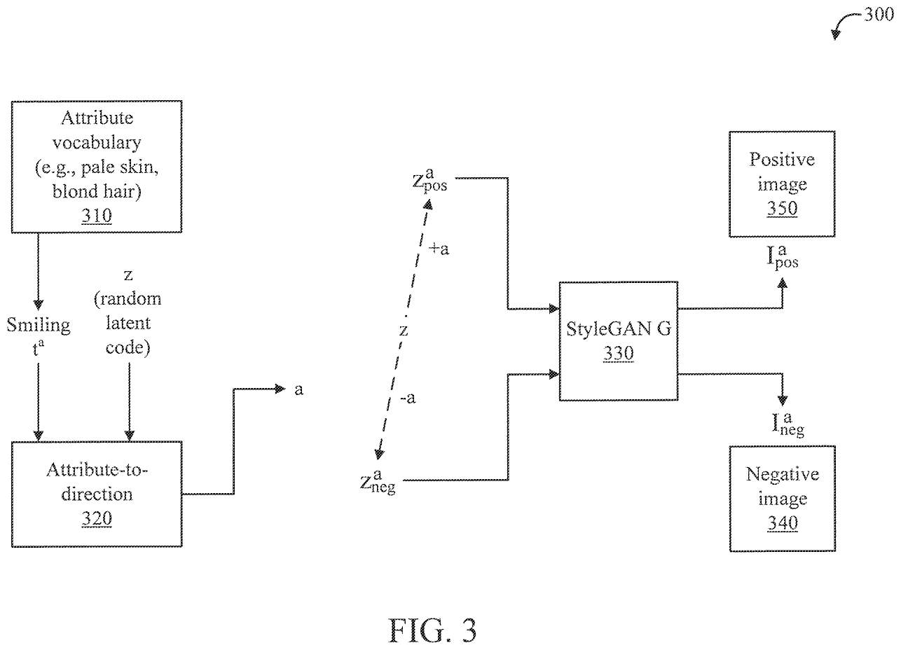

FIG. 3 is a block diagram identifying disentangled attribute directions 300 by training an Attribute-to-Direction module with proposed semantic matching loss (L_{semantic}) and Spatial Constraint (Lₛₚₐₜᵢₐₗ), in accordance with an embodiment of the present invention.

For identifying the attribute latent direction, we propose an Attribute-to-Direction module 320 that takes the random latent code z and word embedding of attributes ta (from an attribute vocabulary 310) as the inputs, outputting the attribute direction a. To ensure that a is semantically matched with the input attribute, we propose the Semantic Matching Loss to train the Attribute-to-Direction module 320. Concretely, a is used to edit z to obtain the positive latent code zₚₒₛ^{a}=z+a and negative latent code z_{neg}^{a}=z−a. zₚₒₛ^{a} is used to synthesize the positive image Iₚₒₛ^{a}=G(zₚₒₛ^{a}) 350 that can reflect the semantic meaning of the attribute output from the StyleGAN 330. While z_{neg}^{a}=G(z_{neg}^{a}) is used to synthesize the negative image I_{neg}^{a}=G(z_{neg}^{a}) 340 that does not contain the information of the given attribute, e.g., not smiling face in FIG. 3. Based on the triplets of (t^{a}, Iₚₒₛ^{a}, I_{neg}^{a}, the Semantic Matching Loss is computed as:

L_{semantic}=max(cos(E_{CLIP}^{img}(I_{neg}^{a}),E_{CLIP}^{text}(t^{a}))−cos(E_{CLIP}^{img}(Iₚₒₛ^{a}),E_{CLIP}^{text}(t^{a}))+α,0), (4)

where α is a hyperparameter as the margin. L_{semantic} attracts attribute text embedding and positive image's embedding and repel the attribute text embedding against negative image's embedding in CLIP's feature space, rendering the attribute direction a to be semantically matched with the attribute.

Attributes Disentanglement with Spatial Constraint

However, the triplet loss cannot ensure that the given attribute is disentangled with other attributes. For example, where the Attribute-to-Direction module is expected to predict an attribute direction of “smiling,” the hair color is also changing. To mitigate this issue, we propose the Spatial Constraint as an additional loss to train the Attribute-to-Direction module. Our motivation is to restrict the spatial variation between the positive and negative images to an intended region, e.g., the mouth region for the “smiling” attribute. To achieve this, we capture the spatial variation by computing the pixel-level difference I_{diff}^{a}=Σ_{c}|Iₚₒₛ^{a}−i_{neg}^{a}|, where c denotes image's channel dimension. Then, the min-max normalization is applied on it to rescale its range to 0 to 1, denoted as Ī_{diff}^{a}. We send the positive image to a weakly-supervised (i.e., supervised by attribute labels) part segmentation method to acquire the pseudo ground-truth mask M^{a}. Finally, the proposed Spatial Constraint is computed as:

Lₛₚₐₜᵢₐₗ=BCE(Î_{diff}^{a},M^{a}), (5)

where BCE denotes binary cross-entropy loss. Minimizing spatial will penalize the spatial variations out of the pseudo ground-truth mask. In this way, the Attribute-to-Direction module is forced to predict the attribute direction that can edit the image in the intended region.

In addition, similar with the Norm Penalty used for the Text-to-Direction module, we also add it for the Attribute-to-Direction module to ensure the image quality. As a summary, the full objective function for training the Attribute-to-Direction module is:

Lₐ=L_{semantic}+Lₛₚₐₜᵢₐₗ+Lₙₒᵣₘ (6).

Compositional Attributes Adjustment

As the Text-to-Direction module may fail to generalize well to text containing unseen or underrepresented compositions of attributes, we propose novel Compositional Attributes Adjustment (CAA) to ensure the compositionality of the text-to-image synthesis results. The key idea of Compositional Attributes Adjustment is two-fold. First, we identify the attributes that the sentence direction s incorrectly predicts based on its agreement with the attribute direction. Second, once we identify the wrongly predicted attributes, we add these attribute directions as the correction to adjust the sentence direction. Concretely, during the inference stage, K attributes {tᵢ^{a}}ᵢ₌₁^{K} will be extracted from the sentence t, and then be fed into the Attribute-to-Direction module along with the random latent code z used for predicting the sentence direction s to obtain the attribute direction {aᵢ}ᵢ₌₁^{K}. Based on the attribute directions, we adjust the sentence direction s to s′ by:

$$A = \{ {a}_{i} \vert cos ( {a}_{i} , s ) \leq 0 \} , {s}^{′} = s + {\sum }_{{a}_{i} ∈ A} \frac{{a}_{i}}{{‖ {a}_{i} ‖}_{2}} \qquad ( 7 )$$

where cos(⋅,⋅) denotes cosine similarity and s′ stands for the attribute-adjusted sentence direction. A is a set of attributes directions that have a less or equal to zero cosine similarity with the sentence direction. When cos(aᵢ, s)<0, the sentence direction s is not agreed with i-th attribute direction aᵢ, indicating that s fails to reflect the i-th attribute in the input text. By adding the i-th attribute direction

$$\frac{{a}_{i}}{{‖ {a}_{i} ‖}_{2}} ,$$

the adjusted sentence direction s′ is corrected to reflect the i-th attribute, leading to a better compositionality of the text-to-image synthesis results.

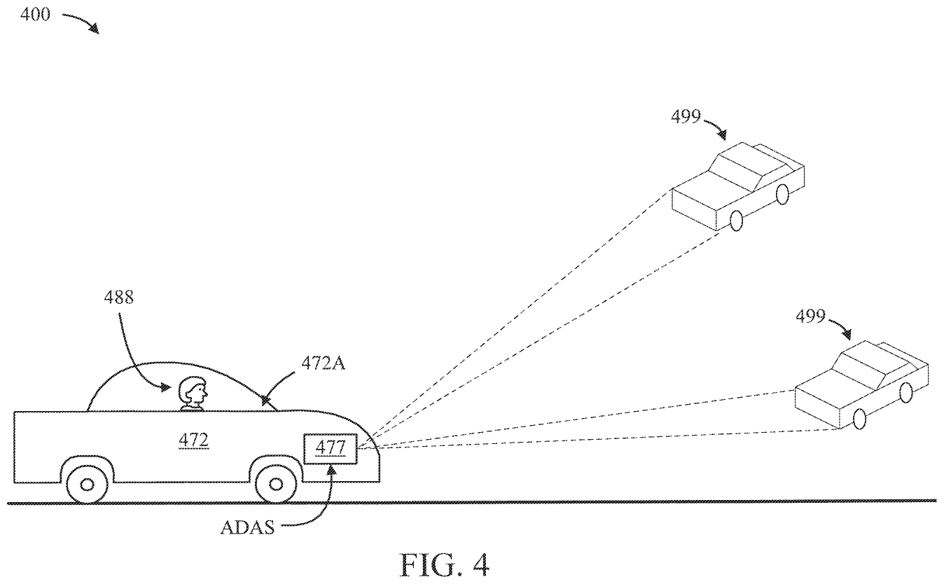

FIG. 4 is a block diagram showing an exemplary environment 400 to which the present invention can be applied, in accordance with an embodiment of the present invention.

In the environment 400, a user 488 is located in a scene with multiple objects 499, each having their own locations and trajectories. The user 488 is operating a vehicle 472 (e.g., a car, a truck, a motorcycle, etc.) having an ADAS 477.

The ADAS 477 inputs a generated synthetic image from an output of method 500.

Responsive to the generated synthetic image, a vehicle controlling decision is made. The image can show an impending collision, warranting evasive action by the vehicle. To that end, the ADAS 477 can control, as an action corresponding to a decision, for example, but not limited to, steering, braking, and accelerating systems.

Thus, in an ADAS situation, steering, accelerating/braking, friction (or lack of friction), yaw rate, lighting (hazards, high beam flashing, etc.), tire pressure, turn signaling, and more can all be efficiently exploited in an optimized decision in accordance with the present invention.

The system of the present invention (e.g., system 400) may interface with the user through one or more systems of the vehicle 472 that the user is operating. For example, the system of the present invention can provide the user information through a system 472A (e.g., a display system, a speaker system, and/or some other system) of the vehicle 472. Moreover, the system of the present invention (e.g., system 400) may interface with the vehicle 472 itself (e.g., through one or more systems of the vehicle 472 including, but not limited to, a steering system, a braking system, an acceleration system, a steering system, a lighting (turn signals, headlamps) system, etc.) in order to control the vehicle and cause the vehicle 472 to perform one or more actions. In this way, the user or the vehicle 472 itself can navigate around these objects 499 to avoid potential collisions there between. The providing of information and/or the controlling of the vehicle can be considered actions that are determined in accordance with embodiments of the present invention.

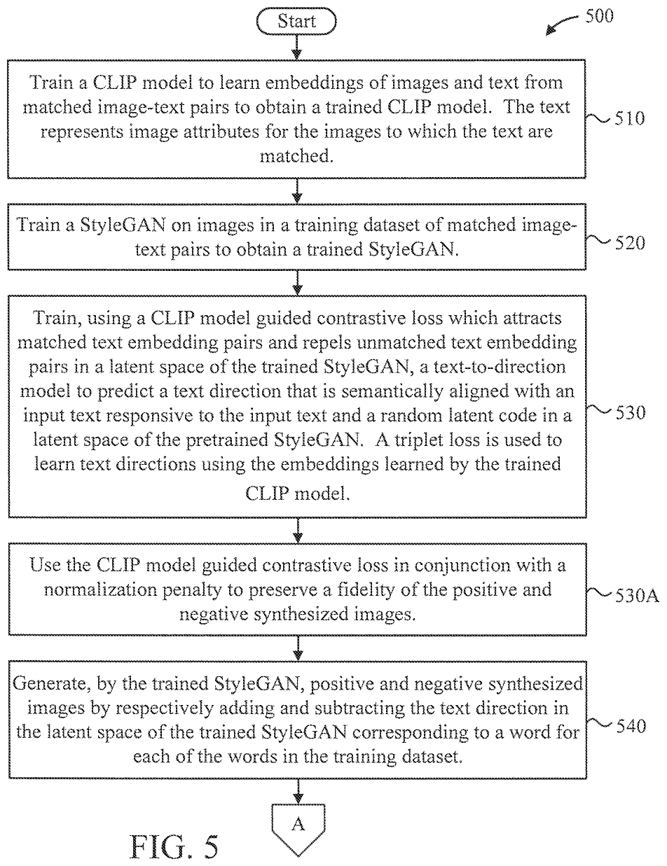

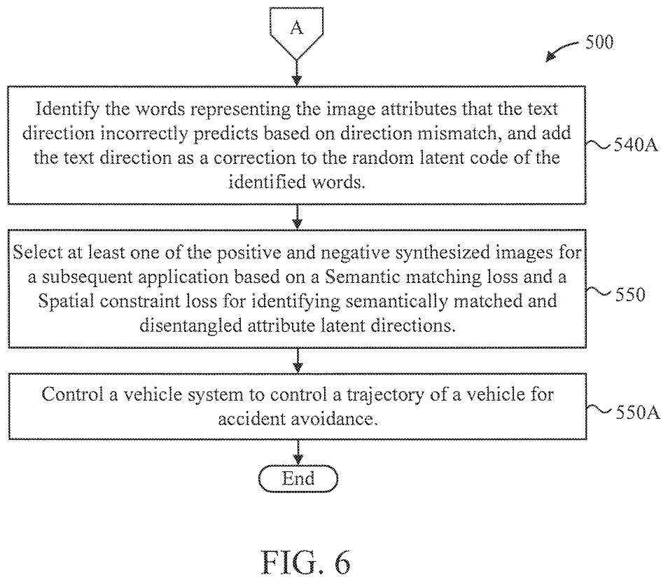

FIGS. 5-6 are block diagrams showing an exemplary method 500, in accordance with an embodiment of the present invention.

At block 510, train a CLIP model to learn embeddings of images and text from matched image-text pairs to obtain a trained CLIP model. The text represents image attributes for the images to which the text are matched.

At block 520, train a StyleGAN on images in a training dataset of matched image-text pairs to obtain a trained StyleGAN.

At block 530, train, using a CLIP model guided contrastive loss which attracts matched text embedding pairs and repels unmatched text embedding pairs in a latent space of the trained StyleGAN, a text-to-direction model to predict a text direction that is semantically aligned with an input text responsive to the input text and a random latent code in a latent space of the pretrained StyleGAN. A triplet loss is used to learn text directions using the embeddings learned by the trained CLIP model.

In an embodiment, block 530 can include block 530A.

At block 530A, use the CLIP model guided contrastive loss in conjunction with a normalization penalty to preserve a fidelity of the positive and negative synthesized images.

At block 540, generate, by the trained StyleGAN, positive and negative synthesized images by respectively adding and subtracting the text direction in the latent space of the trained StyleGAN corresponding to a word for each of the words in the training dataset.

In an embodiment, block 540 can include block 540A.

At block 540A, identify the words representing the image attributes that the text direction incorrectly predicts based on direction mismatch, and add the text direction as a correction to the random latent code of the identified words.

At block 550, select at least one of the positive and negative synthesized images for a subsequent application based on a Semantic matching loss and a Spatial constraint loss for identifying semantically matched and disentangled attribute latent directions.

In an embodiment, block 550 can include block 550A.

At block 550A, control a vehicle system to control a trajectory of a vehicle for accident avoidance. For example, any one or more vehicle systems can be controlled including steering, braking, and accelerating to name a few. Other systems such as lights, signaling, audio, and so forth can also be controlled to indicate an impending accident and/or otherwise aid in avoiding an accident.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
training, by a hardware processor, a Contrastive Language-Image Pre-Training (CLIP) model to learn embeddings of images and text from matched image-text pairs to obtain a trained CLIP model, the text representing image attributes for the images to which the text are matched;
training, by the hardware processor, a Style Generative Adversarial Network (StyleGAN) on images in a training dataset of matched image-text pairs to obtain a trained StyleGAN;
training, by the hardware processor using a CLIP model guided contrastive loss which attracts matched text embedding pairs and repels unmatched text embedding pairs in a latent space of the trained StyleGAN, a text-to-direction model to predict a text direction that is semantically aligned with an input text responsive to the input text and a random latent code in a latent space of the pretrained StyleGAN, wherein a triplet loss is used to learn text directions using the embeddings learned by the trained CLIP model; and
generating, by the trained StyleGAN, positive and negative synthesized images by respectively adding and subtracting the text direction in the latent space of the trained StyleGAN corresponding to a word for each of the words in the training dataset.

2. The computer-implemented method of claim 1, further comprising selecting at least one of the positive and negative synthesized images for a subsequent application based on a semantic matching loss and a spatial constraint loss for identifying semantically matched and disentangled attribute latent directions.

3. The computer-implemented method of claim 2, wherein the subsequent application comprises controlling a vehicle system to control a trajectory of a vehicle for accident avoidance.

4. The computer-implemented method of claim 1, further comprising:
identifying the words representing the image attributes that the text direction incorrectly predicts based on direction mismatch; and
adding the text direction as a correction to the random latent code of the identified words.

5. The computer-implemented method of claim 1, wherein the CLIP model guided contrastive loss is used in conjunction with a normalization penalty to preserve a fidelity of the positive and negative synthesized images by penalizing a norm of the text direction to encourage the latent code to stay in a high-density region in the latent space.

6. The computer-implemented method of claim 1, wherein a latent direction in the latent space of the StyleGAN represents an attribute.

7. The computer-implemented method of claim 1, further comprising traversing the latent code along the text direction to edit an attribute in a synthesized one of the positive and negative synthesized images.

8. A computer program product for text-to-image synthesis, the computer program product comprising a non-transitory computer readable storage medium having program instructions embodied therewith, the program instructions executable by a computer to cause the computer to perform a method comprising:
training, by a hardware processor, a Contrastive Language-Image Pre-Training (CLIP) model to learn embeddings of images and text from matched image-text pairs to obtain a trained CLIP model, the text representing image attributes for the images to which the text are matched;
training, by the hardware processor, a Style Generative Adversarial Network (StyleGAN) on images in a training dataset of matched image-text pairs to obtain a trained StyleGAN;
training, by the hardware processor using a CLIP model guided contrastive loss which attracts matched text embedding pairs and repels unmatched text embedding pairs in a latent space of the trained StyleGAN, a text-to-direction model to predict a text direction that is semantically aligned with an input text responsive to the input text and a random latent code in a latent space of the pretrained StyleGAN, wherein a triplet loss is used to learn text directions using the embeddings learned by the trained CLIP model; and
generating, by the trained StyleGAN, positive and negative synthesized images by respectively adding and subtracting the text direction in the latent space of the trained StyleGAN corresponding to a word for each of the words in the training dataset.

9. The computer program product of claim 8, further comprising selecting at least one of the positive and negative synthesized images for a subsequent application based on a Semantic matching loss and a Spatial constraint loss for identifying semantically matched and disentangled attribute latent directions.

10. The computer program product of claim 9, wherein the subsequent application comprises controlling a vehicle system to control a trajectory of a vehicle for accident avoidance.

11. The computer program product of claim 8, further comprising:
identifying the words representing the image attributes that the text direction incorrectly predicts based on direction mismatch; and
adding the text direction as a correction to the random latent code of the identified words.

12. The computer program product of claim 8, wherein the CLIP model guided contrastive loss is used in conjunction with a normalization penalty to preserve a fidelity of the positive and negative synthesized images by penalizing a norm of the text direction to encourage the latent code to stay in a high-density region in the latent space.

13. The computer program product of claim 8, wherein a latent direction in the latent space of the StyleGAN represents an attribute.

14. The computer program product of claim 8, further comprising traversing the latent code along the text direction to edit an attribute in a synthesized one of the positive and negative synthesized images.

15. A computer processing system, comprising:
a memory device for storing program code; and
a hardware processor operatively coupled to the memory device for running the program code to:
train a Contrastive Language-Image Pre-Training (CLIP) model to learn embeddings of images and text from matched image-text pairs to obtain a trained CLIP model, the text representing image attributes for the images to which the text are matched;
train a Style Generative Adversarial Network (StyleGAN) on images in a training dataset of matched image-text pairs to obtain a trained StyleGAN;
train, using a CLIP model guided contrastive loss which attracts matched text embedding pairs and repels unmatched text embedding pairs in a latent space of the trained StyleGAN, a text-to-direction model to predict a text direction that is semantically aligned with an input text responsive to the input text and a random latent code in a latent space of the pretrained StyleGAN, wherein a triplet loss is used to learn text directions using the embeddings learned by the trained CLIP model,
wherein the trained StyleGAN generates positive and negative synthesized images by respectively adding and subtracting the text direction in the latent space of the trained StyleGAN corresponding to a word for each of the words in the training dataset.

16. The computer processing system of claim 15, wherein the hardware processor further runs the program code to select at least one of the positive and negative synthesized images for a subsequent application based on a semantic matching loss and a spatial constraint loss for identifying semantically matched and disentangled attribute latent directions.

17. The computer processing system of claim 16, wherein the subsequent application comprises controlling a vehicle system to control a trajectory of a vehicle for accident avoidance.

18. The computer processing system of claim 15, wherein the hardware processor further runs the program code to identify the words representing the image attributes that the text direction incorrectly predicts based on direction mismatch, and add the text direction as a correction to the random latent code of the identified words.

19. The computer processing system of claim 15, wherein the CLIP model guided contrastive loss is used in conjunction with a normalization penalty to preserve a fidelity of the positive and negative synthesized images by penalizing a norm of the text direction to encourage the latent code to stay in a high-density region in the latent space.

20. The computer processing system of claim 15, wherein a latent direction in the latent space of the StyleGAN represents an attribute.
